(19) United States
(12) Patent Application Publication
(10) Pub. No.: US 2014/0186258 A1
(43) Pub. Date: Jul. 3, 2014

(54) METHOD FOR PRODUCING HYDROGEN FROM BIOGAS

(71) Applicant: Laurent Allidieres, Saint-Martin d'Uriage (FR)

(72) Inventor: Laurent Allidieres, Saint-Martin d'Uriage (FR)

(73) Assignee: L'Air Liquide, Société Anonyme pour I'Elude et I' Exploitaton de Procédés Georges Claude, Paris (FR)

(21) Appl. No.: 14/237,956

(22) PCT Filed: Aug. 9, 2012
(86) PCT No.: PCT/FR2012/051877

§ 371 Date: Feb. 10, 2014

(30) Foreign Application Priority Data
Aug. 11, 2011 (FR) 1157294

(51) Int. Cl. C01B 3/26

(52) U.S. Cl. CPC C01B 3/26
USPC 423/650; 422/162

(57) ABSTRACT

The present invention relates to a method for producing hydrogen by steam-reforming biomethane and producing hydrogen by purifying the shifted syngas by PSA, including at least one step of purifying a first portion of the biogas supplied for producing biomethane, which is reformed, the resulting syngas being shifted and purified by PSA. The waste gas from the PSA is used as secondary fuel for the reforming furnace, raw or partially purified biogas being used as primary fuel for the furnace.

### CROSS REFERENCE TO RELATED APPLICATIONS

This application is a 371 of International PCT Application PCT/FR2012/051877, filed Aug. 9, 2012, which claims priority to French Application No. 1157294, filed Aug. 11, 2011, the entire contents of which are incorporated herein by reference.

### BACKGROUND

The present invention relates to a method for producing hydrogen by steam reforming from biogas.

### SUMMARY

More particularly it relates to a method for the production of hydrogen comprising at least one step of making raw biogas available, a step of purifying a portion of the raw biogas to produce biomethane, a step of steam reforming the biomethane emerging from the purification to produce a synthesis gas, as well as subsequent steps for processing the synthesis gas obtained to produce hydrogen, including at least shift and PSA steps.

The hydrogen production units implementing the production of synthesis gas by steam reforming of natural gas need, for performing the step of generating synthesis gas (also known as syngas), to operate the reforming reactors at temperatures of around 800 to 900° C. During the start-up phase of the steam reforming it is necessary to perform an initial heating which will ensure the warming up of the reforming furnace, then allow the start-up of the reforming. This initial heating is normally performed by burning natural gas in a burner associated with the furnace. To avoid damage to the furnace, it needs to be heated progressively and this is therefore performed over a long period of time; said initial fuel is also referred to as the primary fuel. Once the functioning of the installation has stabilised, a large portion of the heat required to ensure the maintenance of the temperature of the furnace and to supply the input of heat required for the reforming reaction of the methane—the endothermic reaction preponderant during reforming—is obtained by burning the waste gas of the hydrogen purification unit by PSA—a unit which, situated downstream of the reforming separates the hydrogen contained in the synthesis gas; said additional fuel is referred to as the secondary fuel—the waste gas from PSA (alone or with other process waste gases), albeit known as the secondary fuel, can supply up to 90% of the fuel needs for the reforming during normal operations. The supplement or “heel of heat” is provided by the primary fuel, that is the natural gas in the case of an installation supplied by natural gas.

At sites where there is no natural gas—lack of a distribution network in particular—but where biogas is available, it is replaced where possible with biomethane, which is biogas purified so that it can be substituted for natural gas; it is essentially free of CO₂, which, present at a content of several tens of percent, is the second largest constituent of biogas.

The terms used in the text to define the biogas in its different degrees of purity—whether it is the term “biogas” or “biomethane”—are used in the context of the invention by giving them the meaning that they normally have in the field and as understood by a person skilled in the art; a person skilled in the art being a person working in the bioenergy sector, and in particular in the purification and use of biogas. Thus the terms biogas and biomethane are defined as indicated in the following.

Biogas is a gas produced by the fermentation of animal or vegetable organic materials in the absence of oxygen (anaerobic fermentation). A biogas typically comprises 45% to 70% by volume methane (CH₄), 30% to 50% by volume carbon dioxide (CO₂), it can also comprise nitrogen (N₂) as well as traces of other components of the sulphide, siloxane or VOC (volatile organic compound) type in particular. It can be collected from landfill sites or can be obtained from a methanisation unit.

Biomethane is a biogas that has undergone an enhanced purification process giving it a composition comparable to that of natural gas, thus making it possible to use it instead of natural gas, it is also identified as a substitute natural gas. In other words, biomethane is a biogas purified so as to respect the specifications of the natural gas for which it is going to be substituted. To be distributed by a network as a substitute for natural gas, biomethane needs to respect the specifications. It is then essentially a matter of having a calorific power sufficient to be at least equivalent to the commercialisable natural gas for which it is substituted. The standards vary according to the distribution networks, and thus the specifications imposed on biomethane may also vary according to the distributed natural gas for which it may be substituted. By way of example, the distribution networks in France distribute two qualities of gas, one gas known as having a “low calorific power”, the gross calorific value (GCV) of which has to be at least equal to 9.5 kWh/Nm³, and a gas with a high calorific power, the GVC of which is at least equal to 10/kWh/Nm³.

The purification of biogas into biomethane consists essentially of eliminating CO₂, in order to increase the methane content, but it must be accompanied by the elimination of harmful elements present in the biogas, including at least sulphurous compounds, but also siloxanes as well as VOCs.

Used as a natural gas substitute in the distribution networks, biomethane can also be used as a substitute for natural gas to produce hydrogen.

When biomethane is used as a substitute for natural gas to produce hydrogen, it is logically used also to meet the need for heat usually met by natural gas in installations processing natural gas (warming up of the reformer and heel of heat in particular).

Thus, as already mentioned, the purification of biogas into biomethane consists of eliminating unwelcome elements such as sulphurous compounds and siloxanes and/or VOCs, but mainly CO₂ present in a significant quantity in the biogas, in order to increase the concentration of methane, the cost of this purification is therefore high (40-70 EUR/MWh). Thus, in the case of an installation for steam reforming of methane operating with biomethane, using the gas supplied to the reformer as primary fuel (that is fuel during the start-up phase, fuel to overcome the lack of waste gas and as a heel during the reforming) is economically disadvantageous.

It is therefore desirable, in order to limit the cost of producing hydrogen by reforming biomethane, to substitute for the biomethane a fuel that is less expensive, in terms of OPEX and/or CAPEX, than the process gas, but which is available at the reforming-installation site in the same way as the process gas.

The aim of the present invention is in particular to respond to this need to supply fuel at a lower cost than the reforming gas whilst having the same availability.

The invention proposes for this purpose to use not biomethane but biogas for the primary fuel requirements. Having a purity which can be much lower than that of the biomethane used for reforming, its cost will therefore be much lower. It could consist of a raw biogas—i.e. not purified, the cost of which (<10 EUR/MWh) is much lower (6 to 10 times less expensive). It could also be—depending on the case—partially purified biogas (in this case pre-purification, or pretreatment or primary treatment etc. is also spoken of).

It could be necessary within the context of the invention to differentiate the degrees of purification of biogas before achieving the purity of biomethane, this is why biogas as it comes from anaerobic fermentation (=in the absence of oxygen) will be−if justified by the context—identified as raw biogas.

According to one subject matter of the invention, it is proposed a method for the production of hydrogen from biogas comprising at least the following steps:
a step (a) of making available raw biogas containing 45% to 70% CH₄, 30% to 50% CO_{2:} as well as compounds of the sulphide, siloxane and/or VOC type
a step (b) of purifying a first portion of the biogas for producing biomethane, comprising:
   a step (b₀) of pre-purification intended to eliminate at least sulphide-type compounds and preferably siloxanes and VOCs,
   a step (b1 ) of eliminating CO₂ so as to produce biomethane containing less than 8% CO₂, preferably less than 5% CO₂, more preferably less than 2.5% CO₂,
a step (c) of steam reforming of the biomethane produced in step (b) to obtain a synthesis gas containing at least hydrogen and carbon monoxide, as well as carbon dioxide, methane, water vapour and impurities,
a step (d) of shift reaction for oxidising the majority of carbon monoxide into carbon dioxide in the presence of water with the corresponding production of hydrogen,
a step (e) of separating constituents of the dry synthesis gas in an adsorption unit by pressure modulation (or H₂ PSA) making it possible to obtain a hydrogen-rich flow and a flow of PSA waste gas,
a step (f) of recycling all or a portion of the PSA waste gas to supply the burners of the steam reforming furnace of step (c) with secondary fuel,
a step (g) of supplying the reforming furnace burners with primary fuel provided from the second portion of the raw biogas of step (a).

The biogas supplying the burners contains a significant proportion of CO₂, however, since it consists of carbon dioxide from a renewable and non-fossil source, it is therefore considered to have a neutral environmental impact.

The method comprises, downstream of the generation of synthesis gas (or syngas), steps which are not specified here, including steps of cooling the synthesis gas from the reforming with the recuperation of the available heat, cooling the shifted synthesis gas, with the separation of the condensed water contained in the syngas, possible additional drying as well as other known steps.

The solution proposed by the invention for the use of biogas (raw or partially purified) for the thermal needs of the reformer, saves some of the costs of producing hydrogen which produced in that way is called renewable (since it comes from the reforming of gas coming from the biogas). The use of biogas as a fuel may enable to save up to 10% on the OPEX.

A second advantage of this use is that it makes it possible to reduce the size of the biogas purification unit to produce biomethane. This is because limiting the use of biomethane to reactions producing hydrogen is essentially not eliminating the carbon dioxide in the biogas intended for combustion. Because of the high CO₂ content in the biogas, this makes it possible to reduce considerably the size of the purification unit producing the biomethane. It should be noted that the installation needs to be dimensioned so as to be capable of providing a sufficient amount of primary fuel to meet all of the heating needs of the reformer in the start-up phase, but also in the case of a malfunction in the supply of secondary fuel (waste product of PSA in general). This makes it possible to achieve a gain of 30% on the CAPEX of the purification.

Depending on the individual case the method according to the invention can have one or more of the following features:
the biogas supplying the burners according to step (g) can be raw biogas; this is because, by using suitable burners and a suitable treatment of combustion gases prior to their sending to the atmosphere, it is possible to use a raw biogas as a fuel, without previous processing;
preferably, the second portion of raw biogas intended to supply the primary fuel supplying step (g) is subjected, prior to said step (g), to a step (gₒ) of partial purification so as to produce a biogas free of sulphides, and preferably of siloxanes and VOCs.
step (g₀) of partial purification of the second portion of biogas and step (b₀) of pre-purification of the first portion of biogas can advantageously be a step common to the processing of the whole raw biogas from step (a), the resulting biogas being then separated into two portions, the first portion of biogas supplying step (b₁) and the second portion of biogas, suitable to be sent to the burners, supplying step (g).

The partial purification step (pre-purification) comprises a step of eliminating hydrogen sulphide present in the biogas, this elimination of hydrogen sulphide can be performed by adsorption with a lost charge of adsorbents to be replaced periodically (active carbons), or by any other method known to a person skilled in the art.

Depending on the method used for the implementation of step (b₁) of the elimination of carbon dioxide, said step of pre-purification (or partial purification) includes—as the case may be—an elimination of siloxanes, and/or volatile organic compounds (VOCs) which can be performed for example by adsorption at a modulated temperature (TSA).

The elimination of CO₂ during the purification of the charge to be reformed to produce the biomethane can be performed by various methods; it is preferably performed by selective permeation.

According to another aspect of the invention, the latter relates to an installation for the production of hydrogen from biogas comprising at least:
a source of raw biogas,
means for the pre-purification and elimination of CO₂ from a first portion of the biogas to produce biomethane,
a reforming module,
a shift module,
a PSA module for the production of hydrogen,
means for recycling the PSA waste gas as well as for supplying the burners of the reforming module with secondary fuel,
means for supplying the burners of the reforming module with primary fuel provided from the second portion of raw biogas from step (a).

The following installations are variants of the installation above for the implementation of preferred methods.

According to a first variant, the installation comprises means for supplying the burners of the reforming module with raw biogas coming from the second portion of the raw biogas of step (a).

According to another variant of the installation, the latter comprises means for the elimination of at least sulphide compounds and/or siloxanes and/or VOCs to produce a fuel able to supply the burners of the reforming furnace.

According to a third variant, the installation comprises means for partial purification able to perform a common step of processing the whole raw biogas of step (a), means for separating the resulting biogas into two portions, means for supplying step (b₁) with the first portion of biogas and means for supplying step (g) with the second portion of biogas.

### BRIEF DESCRIPTION OF THE DRAWINGS

Other features and advantages of the present invention will be given in the following description of exemplary embodiments which are not restrictive, the descriptions being made with reference to the attached figures in which:

FIG. 1 shows a schematic view of a method for the production of hydrogen from biogas, integrating a steam reformer with a biogas purification unit according to the prior art.

FIG. 2 is a schematic view of a method for the production of hydrogen from biogas, integrating a steam reformer with a biogas purification unit, using—in application of the invention—raw biogas as a fuel, in replacement for the reformer charge gas.

FIG. 3 is a schematic view of a variant of the method for producing hydrogen from biogas, integrating a steam reformer with a biogas purification unit according to the invention, using prepurified biogas as a fuel, in replacement for the reformer charge gas.

### DESCRIPTION OF PREFERRED EMBODIMENTS

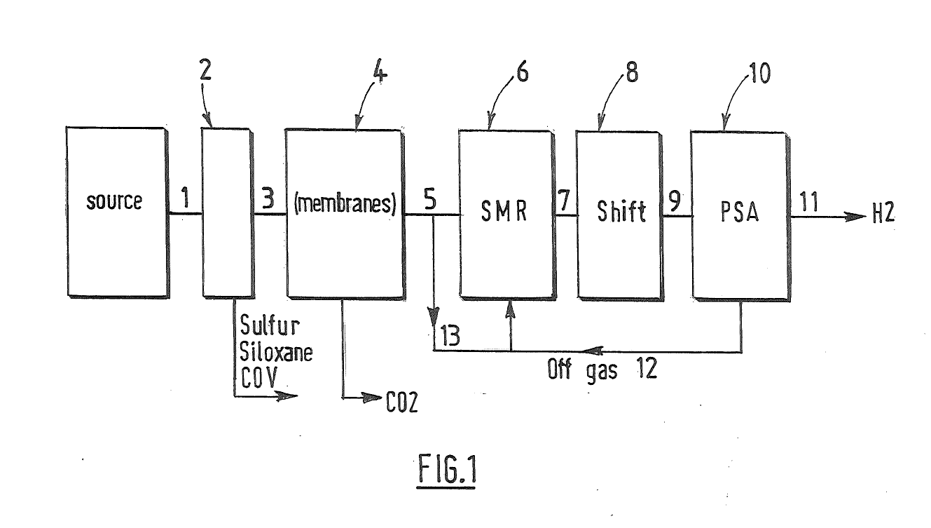

According to FIG. 1—illustrating the prior art—the raw biogas 1 containing 45% to 70% CH₄, 30% to 50% CO₂, nitrogen (N₂), as well as sulphides, traces of siloxanes, VOCs and other components, is purified in two steps: during a first step of pre-purification 2, the compounds derived from sulphur, the siloxanes and the VOCs are eliminated to supply the pre-purified biogas 3, the pre-purified biogas is then subjected to a step 4 of eliminating CO₂ using a membrane technique intended to remove its CO₂ so as to produce biomethane 5.

The biomethane 5 is then used for the production of hydrogen according to a standard method the main steps of which are mentioned in the following: steam reforming in a reformer 6 for producing a syngas 7, which then reacts with water vapour, in the presence of an appropriate catalyst, in 8, to produce a shifted syngas 9 the essential components of which are H₂ and CO₂, then the shifted syngas 9 is purified via a PSA 10 to provide hydrogen 11 and a gaseous waste product 12. This PSA waste gas 12 is used as the secondary fuel in the reformer.

A fraction 13 of the biomethane 5 is removed to be used as a primary fuel for heating the reformer.

Of course, the production of hydrogen involves a much more complex method than that of FIG. 1 but, as already indicated in the description, it is necessary to consider that the progress of the method, from the entry point of the charge into the reformer, is similar to that for the production of hydrogen from a supply of standard natural gas.

It should be noted that the steps of pre-purification and elimination of CO₂ are not described in detail here; more or less complex according to the individual case they produce flows that are not shown, which can be used in a known manner, to be for example recycled or used for the various regeneration steps in the method.

For an installation functioning with natural gas and producing 268 Net of hydrogen, in normal operation, about 500 kW thermal (NCV) are used to maintain the temperature of the furnace and supply the heat for the reforming reaction. Of said 500 kW, 150 kW come from natural gas and 350 kW come from the recirculation of the PSA waste gas.

In case of a stoppage in the recirculation loop of the PSA waste gas (malfunction of PSA, fault in the loop, etc.), the installation needs to have the ability to operate at the nominal rate solely by using natural gas to provide the reaction heat, i.e. at 500 kW. This is because, when the furnace starts up or the PSA stops functioning, the whole thermal charge of 500 kW necessary to produce 268 Nm³/h of hydrogen needs to be able to come from the primary fuel.

In the case of a standard system using biogas which operates according to the standard operating mode of FIG. 1, the system therefore integrates the purification of biogas into biomethane (substitute natural gas) and the reforming of biomethane, this involves sizing the purification installation upstream of the reformer to be able to process the flow of methane fuel corresponding to the full heat load of the reformer (500 kW, i.e. 50 Nm³/h of CH₄) in addition to the methane strictly necessary for the reforming reaction to produce hydrogen (100 Nm³/h). Consequently, in the standard configuration illustrated in FIG. 1, this means oversizing the biogas purification installation (into biomethane) by a factor of 1.5 to be able to produce sufficient biomethane to supplement the lack of secondary fuel in the case of a stoppage suffered by the PSA at full load or during a start-up. Moreover, the installation needs to be able to react in an instantaneous manner to the demand for a corresponding primary fuel flow, which potentially complicates the control system, compared with an installation functioning on natural gas.

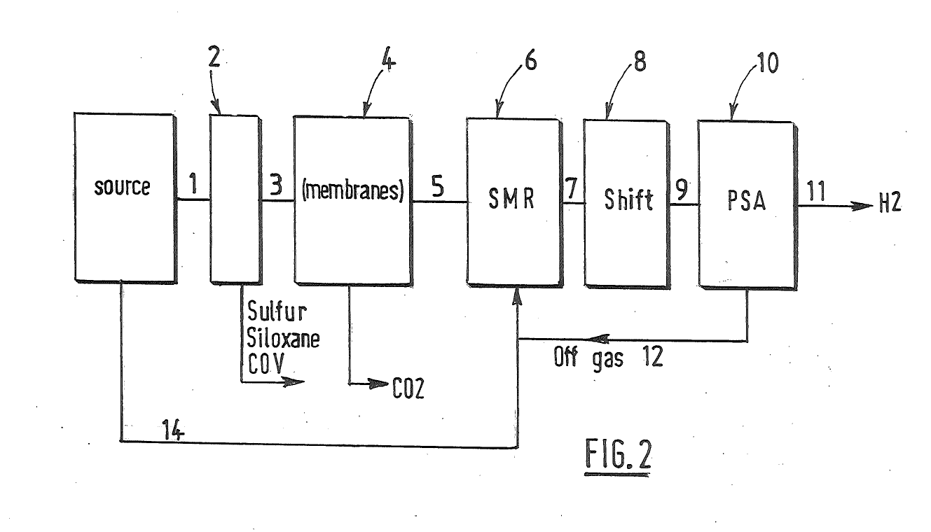

FIG. 2 represents a method for the production of hydrogen from biogas according to the invention, integrating a steam reformer with a biogas purification unit, using raw biogas as fuel. All of the flows as well as the elements of the installation common to the various figures have the same reference numbers. The method of FIG. 2 is different from that of FIG. 1, i.e. the prior art, in that the whole flow 5 of purified biogas is used to produce hydrogen, and in that a flow of raw biogas 14 is removed from the source to be used as a primary fuel for heating the reformer. This method applies to cases where the reformer is able to receive a fuel containing compounds of the sulphide, siloxane and VOC type; i.e. it has at least suitable burners and is equipped to process the fumes.

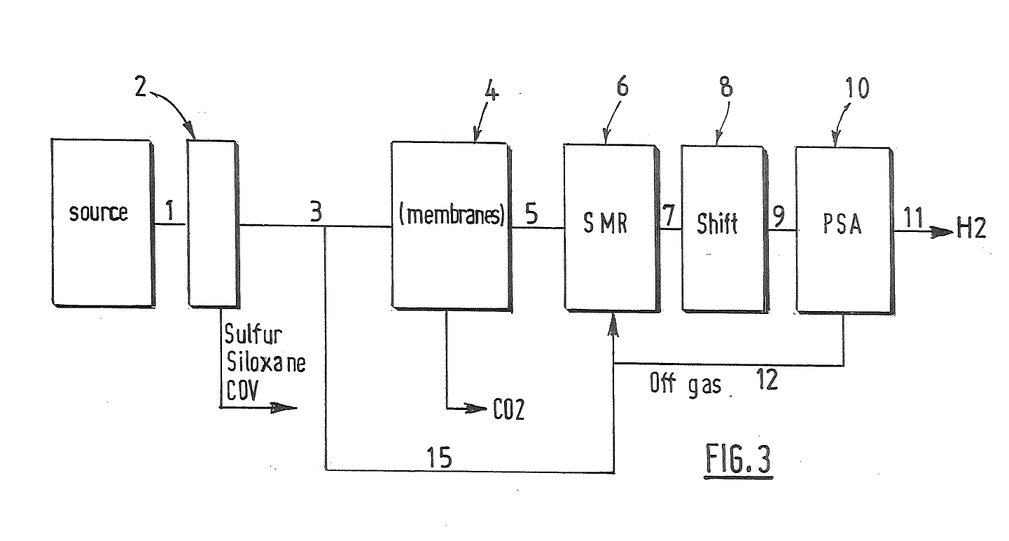

A second variant of the invention is shown in FIG. 3, according to which the whole flow 1 of raw biogas is pre-purified at 2, so as to eliminate harmful components (sulphides and/or siloxanes and/or VOCs), and a flow 15 of partially purified biogas is removed from the flow 3, thus forming the second portion of biogas, which is intended to be used as a primary fuel for heating the reformer.

The first portion of pre-purified biogas is then processed by membranes (MEDAL method in particular) to remove the CO₂, so as to provide biomethane.

In the case of the method according to the invention, according to FIG. 2 or FIG. 3, the heat heel necessary to the reaction—provided in a known manner by natural gas—to produce 268 Nm³/h (corresponding to a power of 150 kW in NCV)—is then provided by raw biogas according to the method of FIG. 2, or by biogas that is pre-purified and therefore free from sulphide or siloxane or VOC components according to FIG. 3. With a biomethane cost of 50 EUR/MWh and that of biogas being less than 10 EUR/MWh, during normal operation the operating cost of the whole purification system is reduced by 10%.

Moreover, as explained above, using biogas (which has not had its CO₂ removed) to supply heat to the furnace in the case of a degraded operation (stoppage of PSA or start-up of the installation) makes it possible to reduce by a factor of 30% the cost of the installation for pre-treating biogas, the biomethane produced being used exclusively for the hydrogen production reaction.

Of course, the invention is not limited to the aforementioned methods of purification, it is also possible to use other pre-purification and purification techniques, as well as regeneration, processing and recycling associated therewith, which are known in themselves but not described here.

The advantages of the method of the invention include:
with regard to the method, rationalising the processes enabling the purification of the biogas according to the specificity of its uses, in the sense of improving the technical-economic efficiency;
optimising the exploitation of a sustainable energy by means of a geographically distributed use.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, language referring to order, such as first and second, should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. Method for the production of hydrogen from biogas comprising at least the following steps:
a step (a) of making available a raw biogas containing 45% to 70% CH₄, 30% to 50% CO₂, as well as at least one of a sulphide, siloxane and/or VOC compound,
a step (b) of purifying a first portion of the raw biogas for producing biomethane, comprising:
a step (b₀) of pre-purification intended-to eliminate at least any of the sulphide compound from the raw biogas. and
a step (b1) of eliminating CO₂ so as to produce biomethane containing less than 8% CO₂,
a step (c) of steam reforming of the biomethane produced in step (b), in a steam methane reformer having a furnace burner to obtain a synthesis gas containing at least hydrogen and carbon monoxide, carbon dioxide, methane, and water vapour,
a step (d) of shift reaction for oxidising the majority of carbon monoxide into carbon dioxide in the presence of water with the corresponding production of hydrogen to forma dry synthesis gas,
a step (e) of separating constituents of the dry synthesis gas in an adsorption unit by pressure modulation (or H₂ PSA) to obtain a hydrogen-rich flow and a flow of PSA waste gas depleted of hydrogen,
a step (f) of recycling all or a portion of the PSA waste gas to supply the burners of the steam reforming furnace of step (c) with secondary fuel,
a step (g) of supplying the steam reforming furnace burner with a primary fuel provided from a second portion of the raw biogas of step (a).

2. Method according to claim 1, wherein the biogas supplying the burners according to step (g) is raw biogas that has not been subject to processing to purify for methane content.

3. Method according to claim 1, wherein the second portion of raw biogas intended to provide the primary fuel supplying step (g) is subjected, prior to step (g), to a partial purification step (g₀) so as to produce a biogas free of sulphides.

4. Method according to claim 3, wherein step (g₀) of partial purification of the second portion of biogas and step (b₀) of pre-purification of the first portion of biogas form a step common to the processing of the whole of the raw biogas from step (a), the resulting biogas being then separated into two portions, the first portion of biogas supplying step (b₁) and the second portion of biogas supplying step (g).

5. An installation for producing hydrogen from biogas comprising at least:
a source of raw biogas
A system adapted for pre-purification of the raw biogas to eliminate at least any of the sulphide compound from the raw biogas to form a pre-purified biogas,
A system adapted for elimination of CO₂ from a first portion of the pre-purified biogas to produce biomethane,
a reforming module,
a shift module,
a PSA module adapted for the purification of hydrogen from a shifted syngas,
A system adapted for recycling the PSA waste gas and for supplying a furnace burners of the reforming module with a secondary fuel,
A system for supplying the furnace burners of the reforming module with primary fuel provided from the the source of raw biogas.

6.-8. (canceled)
